(19) United States
(12) Patent Application Publication
(10) Pub. No.: US 2013/0040063 A1
(43) Pub. Date: Feb. 14, 2013

(54) COATING APPARATUS FOR GLASS SUBSTRATE AND COATING METHOD THEREOF

(71) Applicant: Yueyuan Jian, Shenzhen (CN)

(72) Inventor: Yueyuan Jian, Shenzhen (CN)

(73) Assignee: SHENZHEN CHINA STAR OPTOELECTRONICS TECHNOLOGY CO., LTD., Shenzhen (CN)

(21) Appl. No.: 13/318,353

(22) PCT Filed: Aug. 12, 2011
(86) PCT No.: PCT/CN11/78316

§ 371 Date: Oct. 31, 2011

(30) Foreign Application Priority Data
Aug. 9, 2011 (CN) 201110227385.1

(51) Int. Cl. B05D 1/02; B05C 5/00

(52) U.S. Cl. 427/427.3; 118/313

(57) ABSTRACT

The present invention provides a coating apparatus for a glass substrate. The apparatus comprising a main body, and the main body includes a movable base, and the movable base is used to allow the glass substrate to be placed thereon, and the coating apparatus further comprises a first nozzle and a roller. The first nozzle and the roller are disposed at both sides of the main body, respectively, and the first nozzle moves from one side of the main body to the roller along a predetermined trace for pre-dispensing. The present invention further provides a coating method of the coating apparatus for the glass substrate.

### FIELD OF THE INVENTION

The present invention relates to a field of a liquid crystal display technology, and more particularly to a coating apparatus for a glass substrate and a coating method thereof.

### BACKGROUND OF THE INVENTION

In a conventional coating machine, two nozzles are required to be arranged. Referring to FIG. 1, a left nozzle 11 and a right nozzle 12 are disposed at both sides of the coating machine, respectively. The left nozzle 11 corresponds to a left roller 13, and the right nozzle 12 corresponds to a right roller 14.

When coating for a glass substrate, for meeting requirements of parameters in the coating process, firstly, the nozzles are required to be moved to the corresponding rollers for pre-dispensing, respectively.

The rollers are required for the coating machine, and arranged at the two sides thereof, hence increasing the cost and the occupied space thereof. Moreover, for meeting the parameter requirements in the coating process, the rollers need to be soaked and rolled for a long time, thereby wasting a lot of material.

### SUMMARY OF THE INVENTION

An object of the present invention is to provide a coating apparatus for a glass substrate, so as to solve a problem that two rollers are required to be arranged at both sides of the coating machine resulting in the increasing of the cost, occupied space and wasted material.

For solving the above-mentioned problems, the present invention provides a coating apparatus for a glass substrate. The apparatus comprises a main body, wherein the main body includes a movable base, and the movable base is used to allow the glass substrate to be placed thereon, and the coating apparatus further comprises a first nozzle and a roller. The first nozzle and the roller are disposed at both sides of the main body, respectively, and the first nozzle moves from one side of the main body to the roller along a predetermined trace for pre-dispensing. The movable base moves a predetermined distance along a predetermined direction with respect to a horizontal surface of the main body, and the predetermined direction is vertical to the horizontal surface of the main body, and a distance between the predetermined trace and the horizontal surface of the main body is larger than the predetermined distance. The apparatus further comprises a second nozzle, and the second nozzle and the roller are disposed at the same side of the main body, and the second nozzle moves to the roller for pre-dispensing.

In the coating apparatus for the glass substrate of the present invention, before moving along the predetermined trace, the first nozzle is positioned at a predetermined position, and a distance between the predetermined position and the horizontal surface of the main body is larger than the predetermined distance.

In the coating apparatus for the glass substrate of the present invention, the movable base comprises a coating-starting zone and a coating-ending zone, wherein with respect to a middle line of the main body, the coating-starting zone is close to the roller, and the coating-ending zone is close to the predetermined position, and the first nozzle is used to coat for the glass substrate on the movable base from the coating-starting zone, and the first nozzle is positioned at the coating-ending zone after coating for the glass substrate.

In the coating apparatus for the glass substrate of the present invention, after using the first nozzle to coat for the glass substrate, the first nozzle returns from the coating-ending zone to the predetermined trace, and then move to the predetermined position along the predetermined trace.

Another object of the present invention is to provide a coating apparatus for a glass substrate, so as to solve a problem that two rollers are required to be arranged at both sides of the coating machine resulting in the increasing of the cost, occupied space and wasted material.

For solving the above-mentioned problems, the present invention provides a coating apparatus for a glass substrate comprising a main body, wherein the main body includes a movable base, and the movable base is used to allow the glass substrate to be placed thereon, and the coating apparatus further comprises a first nozzle and a roller, and the first nozzle and the roller are disposed at both sides of the main body, respectively, and the first nozzle moves from one side of the main body to the roller along a predetermined trace for pre-dispensing.

In the coating apparatus for the glass substrate of the present invention, the movable base moves a predetermined distance along a predetermined direction with respect to a horizontal surface of the main body, and the predetermined direction is vertical to the horizontal surface of the main body, wherein a distance between the predetermined trace and the horizontal surface of the main body is larger than the predetermined distance.

In the coating apparatus for the glass substrate of the present invention, before moving along the predetermined trace, the first nozzle is positioned at a predetermined position, and a distance between the predetermined position and the horizontal surface of the main body is larger than the predetermined distance.

In the coating apparatus for the glass substrate of the present invention, the movable base comprises a coating-starting zone and a coating-ending zone, wherein with respect to a middle line of the main body, the coating-starting zone is close to the roller, and the coating-ending zone is close to the predetermined position, and the first nozzle is used to coat for the glass substrate on the movable base from the coating-starting zone, and the first nozzle is positioned at the coating-ending zone after coating for the glass substrate.

In the coating apparatus for the glass substrate of the present invention, after using the first nozzle to coat for the glass substrate, the first nozzle returns from the coating-ending zone to the predetermined trace, and then move to the initial position along the predetermined trace.

In the coating apparatus for the glass substrate of the present invention, the apparatus further comprises a second nozzle, and the second nozzle and the roller are disposed at the same side of the main body, and the second nozzle moves to the roller for pre-dispensing.

Another object of the present invention is to provide a coating method of the apparatus for the glass substrate, so as to solve a problem that two rollers are required to be arranged at both sides of the coating machine resulting in the increasing of the cost, occupied space and wasted material.

For solving the above-mentioned problems, the present invention provides a coating method for the glass substrate, and the method comprises the following steps: arranging the glass substrate on a movable base; controlling a first nozzle to move from one side of a main body to a roller along a predetermined trace; controlling the first nozzle to pre-dispense; wherein the roller and the first nozzle are positioned at both sides of the main body, respectively, and the movable base is disposed on the main body.

In the coating method of the coating apparatus for the glass substrate of the present invention, before placing the glass substrate on the movable base, the method further comprises following step: controlling the movable base to move a predetermined distance along a predetermined direction with respect to a horizontal surface of the main body, wherein the predetermined direction is vertical to the horizontal surface of the main body, and a distance between the predetermined trace and the horizontal surface of the main body is larger than the predetermined distance.

In the coating method of the coating apparatus for the glass substrate of the present invention, before controlling the first nozzle to move from one side of the main body to the roller along the predetermined trace, the method further comprises following step: arranging the first nozzle at a predetermined position, wherein a distance between the predetermined position and the horizontal surface of the main body is larger than the predetermined distance.

In the coating method of the coating apparatus for the glass substrate of the present invention, the movable base comprises a coating-starting zone and a coating-ending zone, wherein with respect to a middle line of the main body, the coating-starting zone is close to the roller, and the coating-ending zone is close to the predetermined position, after the pre-dispensing of the first nozzle, the method further comprises following step: controlling the first nozzle to start coating for the glass substrate from the coating-starting zone, wherein the first nozzle is positioned at the coating-ending zone after coating for the glass substrate.

In the coating method of the coating apparatus for the glass substrate of the present invention, after using the first nozzle to coat for the glass substrate, the method further comprises following step: controlling the first nozzle to return from the coating-ending zone to the predetermined trace, and then move to the predetermined position along the predetermined trace.

In the coating method of the coating apparatus for the glass substrate of the present invention, the apparatus further comprises a second nozzle, and the second nozzle and the roller are disposed at the same side of the main body, wherein before the moving of the first nozzle along the predetermined trace, alternatively, after using the first nozzle to coat for the glass substrate, the second nozzle is controlled to move to the roller for pre-dispensing.

In comparison with the conventional technique, the present invention can solve a problem that two rollers are required to be arranged at both sides of the conventional coating machine resulting in the increasing of the cost and occupied space. Thus, the present invention can significantly save material.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a structural diagram showing a conventional coating machine;

FIG. 2 is a structural diagram showing a coating apparatus for a glass substrate according to a preferred embodiment of the present invention;

FIG. 3 is a schematic diagram showing a coating process of the coating apparatus for the glass substrate shown in FIG. 2;

FIG. 4 is a schematic diagram showing a coating process of the coating apparatus for the glass substrate shown in FIG. 2;

FIG. 5 is a schematic diagram showing a coating process of the coating apparatus for the glass substrate shown in FIG. 2;

FIG. 6 is a schematic diagram showing a coating process of the coating apparatus for the glass substrate shown in FIG. 2; and

FIG. 7 is a schematic diagram showing a coating process of the coating apparatus for the glass substrate shown in FIG. 2.

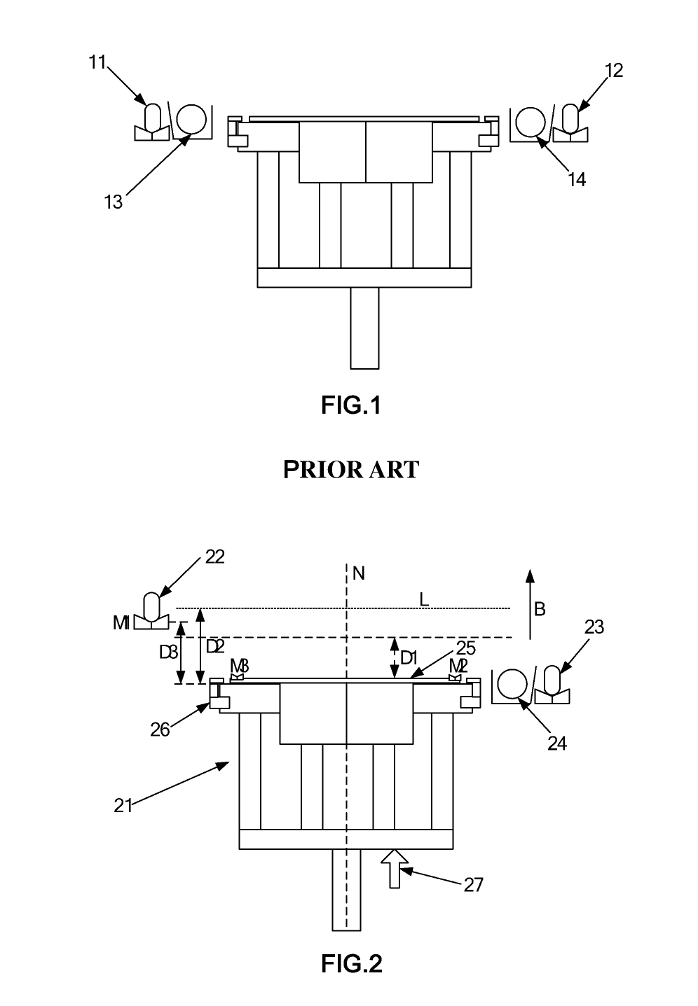

### DETAILED DESCRIPTION OF THE PREFERRED EMBODIMENTS

The following embodiments are referring to the accompanying drawings for exemplifying specific implementable embodiments of the present invention.

FIG. 2 is a schematic diagram showing coating apparatus for a glass substrate according to a preferred embodiment of the present invention.

Referring to FIG. 2, the apparatus comprises a main body 21, a first nozzle 22 and a second nozzle 23, wherein the first nozzle 22 and the second nozzle 23 are disposed at both sides of the main body 21, respectively.

Referring to FIG. 2 again, the apparatus further comprises a roller 24. The roller 24 and the first nozzle 22 are disposed at both sides of the main body 21, and the second nozzle 23 and the roller 24 are disposed at the same side of the main body 21.

Referring to FIG. 2 again, the main body 21 includes a movable base 25. The movable base 25 is used to allow the glass substrate to be placed thereon for coating. In practice, the movable base 25 moves along a predetermined direction B, and the predetermined direction B is vertical to a horizontal surface of the main body 21. In this embodiment, the movable base moves a predetermined distance D1 along the predetermined direction B and with respect to a horizontal surface of the main body 21, so as to place the glass substrate on the movable base 25 to be coated.

In practice, after placing the glass substrate on the movable base 25 to be coated, the movable base 25 returns to the initial position along a direction opposite to the predetermined direction B. At the same time, the first nozzle 22 moves to the roller 24 along a predetermined trace L. In this case, a distance D2 between the predetermined trace L and the horizontal surface of the main body 21 is larger than the predetermined distance D1 for preventing the first nozzle 22 from being blocked by the movable base 25 when moving along the predetermined trace L.

In practice, before entering the predetermined trace L, the first nozzle 22 is positioned at a predetermined position M1. In this case, a distance D3 between the predetermined position M1 and the horizontal surface of the main body 21 is larger than the predetermined distance D1 for preventing the first nozzle 22 from being blocked by the movable base 25 when moving from the predetermined position M1 to the predetermined trace L.

Referring to FIG. 2 again, the movable base 25 comprises a coating-starting zone M2 and a coating-ending zone M3. With respect to a middle line N, the coating-starting zone M2 is close to the roller 24. Therefore, after the pre-dispensing of the first nozzle 22 near the roller 24, the first nozzle 22 can start coating for the glass substrate on the movable base 25. With respect to the middle line N, the coating-ending zone M3 is close to the predetermined position M1. Therefore, after coating for the glass substrate by the first nozzle 22, the first nozzle 22 can easily come back the predetermined position M1.

Referring to FIG. 2 again, the apparatus further comprises a positioner 26 and vacuum tubes 27. The positioner 26 is used to position the movable base 25, and the vacuum tubes 27 are used to maintain or close a vacuum status within the main body 21.

A work process of the coating apparatus shown in FIG. 2 for the glass substrate is described below.

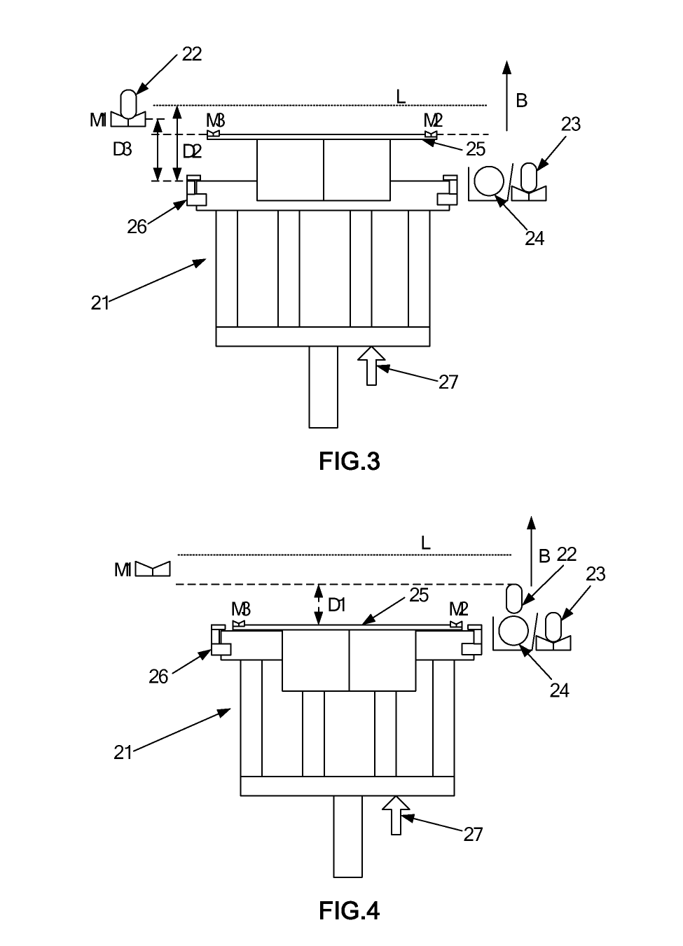

Referring to FIG. 3, when starting coating for the glass substrate, the first nozzle 22 is positioned at the predetermined position M1, and the positioner 26 is turned on, and the movable base 25 can move the predetermined distance D1 along the predetermined direction B, and the glass substrate is placed on the movable base 25 to be coated. At the same time, the vacuum tubes 27 are turned on.

Thereafter, referring to FIG. 4, the movable base 25 returns to the initial position along the direction opposite to the predetermined direction B, and the positioner 26 is turned off. In this case, when the movable base 25 is returning, the first nozzle 22 enters the predetermined trace L from the predetermined position M1 and moves to the roller 24 along a predetermined trace L for pre-dispensing.

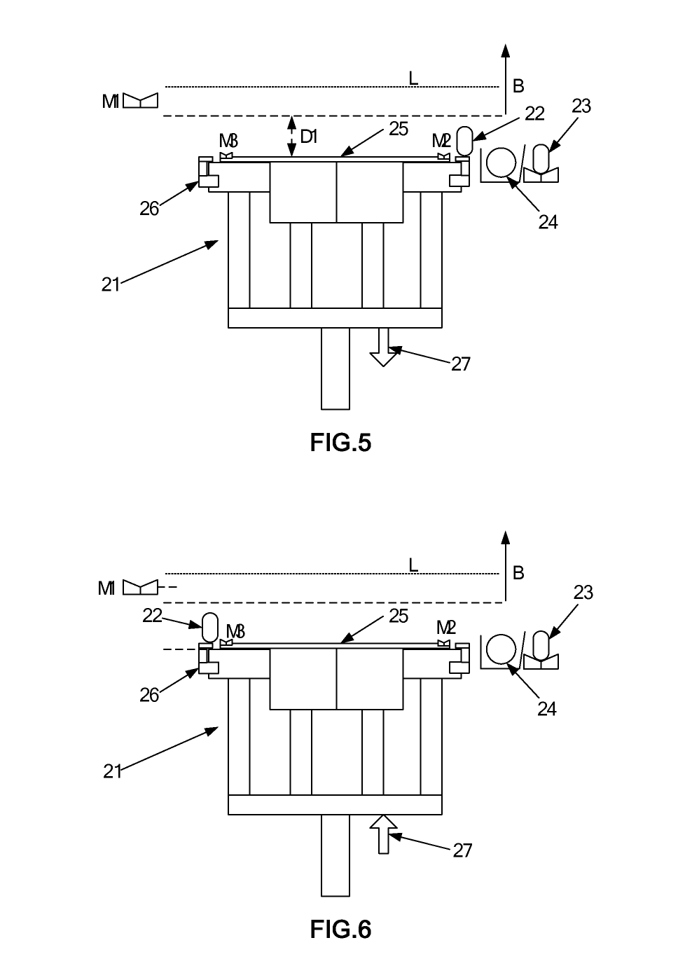

Referring to FIG. 5, after pre-dispensing, the first nozzle 22 enters the coating-starting zone M2 of the movable base 25. At the same time, the positioner 26 is turned on, and the vacuum tubes 27 are turned off, and the first nozzle 22 starts coating for the glass substrate on the movable base 25.

After coating for the glass substrate, referring to FIG. 6, the first nozzle 22 is positioned at the coating-ending zone M3. At the same time, the vacuum tubes 27 are turned on, and the first nozzle 22 is raised to the predetermined trace L, and then the first nozzle 22 is controlled to return to the predetermined position M1.

Thereafter, the movable base 25 moves the predetermined distance D1 along the predetermined direction B for removing the coated glass substrate.

In practice, before the moving of the first nozzle 22 along the predetermined trace L, alternatively, after using the first nozzle 22 to coat for the glass substrate, the second nozzle 23 can further move to the roller 24 for pre-dispensing, and the similarities are not mentioned for simplification.

The coating apparatus for the glass substrate according to the present invention have the following effects:

1). low equipment cost due to the reduction of the roller;

2). shorter length of the coating apparatus and the reduction of the occupied space due to the reduction of the roller; and

3). saving soaker and reducing the rolling time and material due to the reduction of the roller.

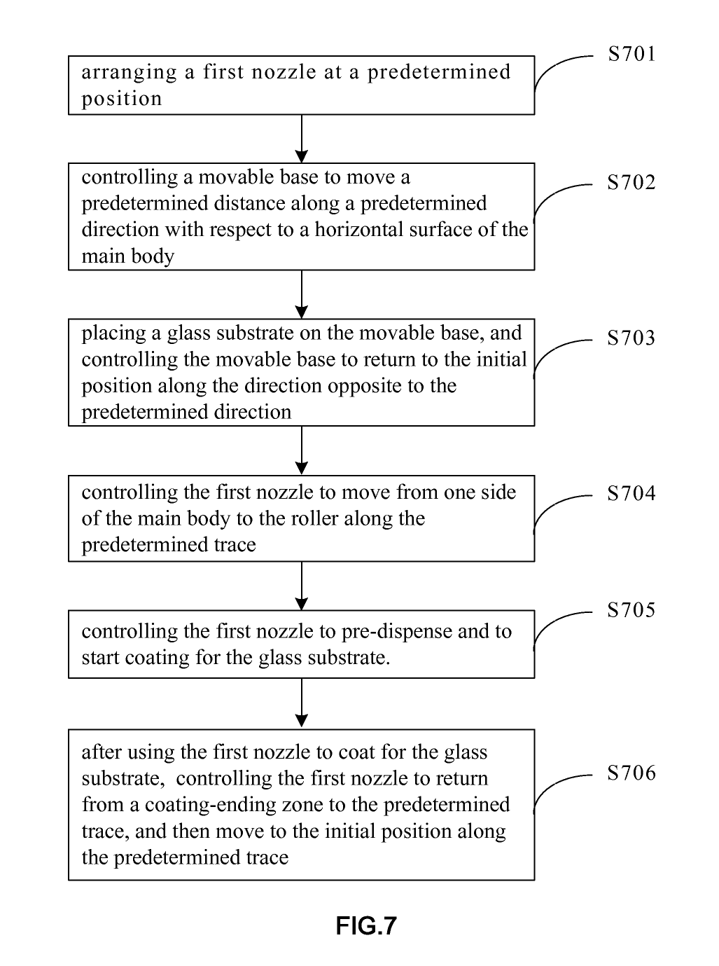

Referring to FIG. 7, a flow diagram showing a coating method of the coating apparatus for the glass substrate according to the present invention is illustrated.

In a step S701, the first nozzle is arranged at the predetermined position.

In a step S702, the movable base is controlled to move the predetermined distance along the predetermined direction with respect to the horizontal surface of the main body.

In a step S703, the glass substrate is placed on the movable base, and the movable base is controlled to return to the initial position along the direction opposite to the predetermined direction.

In a step S704, the first nozzle is controlled to move from one side of the main body to the roller along the predetermined trace.

In this case, the distance between the predetermined trace and the horizontal surface of the main body is larger than the predetermined distance. The roller and the first nozzle are positioned at both sides of the main body, respectively. The movable base is disposed on the main body.

In a step S705, the first nozzle is controlled to pre-dispense and start coating for the glass substrate.

In a step S706, after using the first nozzle 22 to coat for the glass substrate, the first nozzle is controlled to return from the coating-ending zone to the predetermined trace, and then move to the initial position along the predetermined trace.

In this embodiment, the movable base comprises a coating-starting zone and a coating-ending zone. With respect to a middle line of the main body, the coating-starting zone is close to the roller, and the coating-ending zone is close to the predetermined position. The first nozzle starts to coat for the glass substrate on the movable base from the coating-starting zone. After coating for the glass substrate, the first nozzle is positioned at the coating-ending zone.

In this embodiment, the apparatus further comprises the second nozzle, and the second nozzle and the roller are disposed at the same side of the main body. Before the moving of the first nozzle along the predetermined trace, alternatively, after using the first nozzle to coat for the glass substrate, the second nozzle moves to the roller for pre-dispensing.

The present invention has been described with a preferred embodiment thereof and it is understood that many changes and modifications to the described embodiment can be carried out without departing from the scope and the spirit of the invention that is intended to be limited only by the appended claims.

1. A coating apparatus for a glass substrate comprising a main body, wherein the main body includes a movable base, and the movable base is used to allow the glass substrate to be placed thereon, and the coating apparatus further comprises a first nozzle and a roller, characterized in that:
the first nozzle and the roller are disposed at both sides of the main body, respectively, and the first nozzle moves from one side of the main body to the roller along a predetermined trace for pre-dispensing;
wherein the movable base moves a predetermined distance along a predetermined direction with respect to a horizontal surface of the main body, and the predetermined direction is vertical to the horizontal surface of the main body, and a distance between the predetermined trace and the horizontal surface of the main body is larger than the predetermined distance;
wherein the apparatus further comprises a second nozzle, and the second nozzle and the roller are disposed at the same side of the main body, and the second nozzle moves to the roller for pre-dispensing.

2. The coating apparatus for the glass substrate according to claim 1, characterized in that: before moving along the predetermined trace, the first nozzle is positioned at a predetermined position, and a distance between the predetermined position and the horizontal surface of the main body is larger than the predetermined distance.

3. The coating apparatus for the glass substrate according to claim 2, characterized in that: the movable base comprises a coating-starting zone and a coating-ending zone, wherein with respect to a middle line of the main body, the coating-starting zone is close to the roller, and the coating-ending zone is close to the predetermined position, and the first nozzle is used to coat for the glass substrate on the movable base from the coating-starting zone, and the first nozzle is positioned at the coating-ending zone after coating for the glass substrate.

4. The coating apparatus for the glass substrate according to claim 3, characterized in that: after using the first nozzle to coat for the glass substrate, the first nozzle returns from the coating-ending zone to the predetermined trace, and then move to the predetermined position along the predetermined trace.

5. A coating apparatus for a glass substrate comprising a main body, wherein the main body includes a movable base, and the movable base is used to allow the glass substrate to be placed thereon, and the coating apparatus further comprises a first nozzle and a roller, characterized in that:
the first nozzle and the roller are disposed at both sides of the main body, respectively, and the first nozzle moves from one side of the main body to the roller along a predetermined trace for pre-dispensing.

6. The coating apparatus for the glass substrate according to claim 5, characterized in that: the movable base moves a predetermined distance along a predetermined direction with respect to a horizontal surface of the main body, and the predetermined direction is vertical to the horizontal surface of the main body, wherein a distance between the predetermined trace and the horizontal surface of the main body is larger than the predetermined distance.

7. The coating apparatus for the glass substrate according to claim 6, characterized in that: before moving along the predetermined trace, the first nozzle is positioned at a predetermined position, and a distance between the predetermined position and the horizontal surface of the main body is larger than the predetermined distance.

8. The coating apparatus for the glass substrate according to claim 7, characterized in that: the movable base comprises a coating-starting zone and a coating-ending zone, wherein with respect to a middle line of the main body, the coating-starting zone is close to the roller, and the coating-ending zone is close to the predetermined position, and the first nozzle is used to coat for the glass substrate on the movable base from the coating-starting zone, and the first nozzle is positioned at the coating-ending zone after coating for the glass substrate.

9. The coating apparatus for the glass substrate according to claim 8, characterized in that: after using the first nozzle to coat for the glass substrate, the first nozzle returns from the coating-ending zone to the predetermined trace, and then move to the initial position along the predetermined trace.

10. The coating apparatus for the glass substrate according to claim 5, characterized in that: the apparatus further comprises a second nozzle, and the second nozzle and the roller are disposed at the same side of the main body, and the second nozzle moves to the roller for pre-dispensing.

11. A coating method for a glass substrate, characterized in that: the method comprises the following steps:
arranging the glass substrate on a movable base;
controlling a first nozzle to move from one side of a main body to a roller along a predetermined trace; and
controlling the first nozzle to pre-dispense;
wherein the roller and the first nozzle are positioned at both sides of the main body, respectively, and the movable base is disposed on the main body.

12. The coating method for the glass substrate according to claim 11, characterized in that: before placing the glass substrate on the movable base, the method further comprises following step:
controlling the movable base to move a predetermined distance along a predetermined direction with respect to a horizontal surface of the main body;
wherein the predetermined direction is vertical to the horizontal surface of the main body, and a distance between the predetermined trace and the horizontal surface of the main body is larger than the predetermined distance.

13. The coating method for the glass substrate according to claim 12, characterized in that: before controlling the first nozzle to move from one side of the main body to the roller along the predetermined trace, the method further comprises following step:
arranging the first nozzle at a predetermined position;
wherein a distance between the predetermined position and the horizontal surface of the main body is larger than the predetermined distance.

14. The coating method for the glass substrate according to claim 13, characterized in that: the movable base comprises a coating-starting zone and a coating-ending zone, wherein with respect to a middle line of the main body, the coating-starting zone is close to the roller, and the coating-ending zone is close to the predetermined position, after the pre-dispensing of the first nozzle, the method further comprises following step:
controlling the first nozzle to start coating for the glass substrate from the coating-starting zone, wherein the first nozzle is positioned at the coating-ending zone after coating for the glass substrate.

15. The coating method for the glass substrate according to claim 14, characterized in that: after using the first nozzle to coat for the glass substrate, the method further comprises following step:
controlling the first nozzle to return from the coating-ending zone to the predetermined trace, and then move to the predetermined position along the predetermined trace.

16. The coating method for the glass substrate according to claim 11, characterized in that: the apparatus further comprises a second nozzle, and the second nozzle and the roller are disposed at the same side of the main body;
wherein before the moving of the first nozzle along the predetermined trace, alternatively, after using the first nozzle to coat for the glass substrate, the second nozzle is controlled to move to the roller for pre-dispensing.
